(19) United States
(12) Patent Application Publication
(10) Pub. No.: US 2004/0126605 A1
(43) Pub. Date: Jul. 1, 2004

(54) Method of coating a polymer component with an NBC resistant coating

(76) Inventor: Joseph Anthony Griffiths, Surrey (GB)

Correspondence Address: David M. Carter, Carter, DeLuca, Farrell & Schmidt, LLP, Suite 225, 445 Broad Hollow Road, Melville, NY, 11747, US

(21) Appl. No.: 10/692,172

(22) Filed: Oct. 23, 2003

(30) Foreign Application Priority Data
Oct. 23, 2002 (GB) 0224674.2

(51) Int. Cl. B05D 3/02; B05D 1/36; H05H 1/24; H05H 1/00

(52) U.S. Cl. 428/500; 427/569; 427/385.5; 427/407.1; 427/533

(57) ABSTRACT

A method of applying a coating of NBC resistant material to a non-NBC resistant polymeric layer is provided comprising the steps of subjecting a surface of the polymeric layer to be coated to a high frequency and high voltage corona discharge to change said surface to provide a keying surface thereon; and applying the coating of NBC resistant material thereto. A material made by the method is also provided.

### CROSS-REFERENCE TO RELATED APPLICATION

The present application claims the benefit of and priority to United Kingdom Patent Appln. Ser. No. 0224674.2, filed on Oct. 23, 2002, the entire contents of which are incorporated herein by reference.

### BACKGROUND

1. Technical Field

This invention relates to a method of coating a component made from a polymer with a Nuclear, Biological or Chemical (NBC) resistant coating and a component or material made by said method. The invention is however more particularly but not exclusively concerned with the manufacture of diaphragm valves for use in respirators or other equipment for use in an NBC environment.

2. Discussion of Related Art

Known NBC resistant diaphragms are made of a natural or synthetic rubber material which needs to be very thin if they are to work satisfactorily. A problem with these diaphragms however is that, over a period of time, the NBC agents can penetrate the rubber due to absorption and they also become brittle at low temperatures which can have fatal consequences.

It is an object of the invention therefore to provide an NBC resistant material which remains pliable at very low temperatures.

### SUMMARY

According to one aspect of the invention, there is provided an NBC resistant material comprising a non-NBC resistant polymeric layer having an inside and outside surface with a coating of NBC resistant material on one or both of said surfaces.

Preferably, the polymeric layer is vulcanised silicone rubber and the coating NBC resistant material is butyl, most preferably a butyl rubber material.

Whilst silicone rubber coated with butyl will provide an excellent NBC resistant material which remains pliable even at very low temperatures, until now it has not been possible to coat silicone with a butyl covering as it could not be made to adhere to it as the two materials are not compatible.

However, the preferred method of the invention solves this problem by providing a method of applying a coating of butyl to a surface on a layer of silicone rubber comprising the steps of subjecting the silicone rubber surface to be coated to a high frequency and high voltage corona discharge to change said surface and provide a keying surface thereon and applying the coating of butyl thereto.

In the preferred method, the silicone rubber layer is washed with soapy water, rinsed and dried prior to the application thereto of the corona discharge.

Preferably, the butyl is sprayed onto the keying surface on the silicone rubber layer. If more than one coat of butyl is sprayed onto the silicone layer, each coat needs to be allowed to dry before the application of a subsequent layer.

In the preferred method, the silicone rubber material coated with one or more butyl layers is placed in a preheated oven and vulcanised.

Preferably, the oven is preheated to a temperature above about 200° C., most preferably above 200° C. and the vulcanised process takes place for approximately 30 minutes.

### DETAILED DESCRIPTION OF PREFERRED EMBODIMENTS

According to one aspect of the invention, there is provided an NBC resistant material comprising a non-NBC resistant polymeric layer having an inside and outside surface with a coating of NBC resistant material on one or both of said surfaces.

A preferred method of applying an NBC resistant material, most preferably a butyl rubber material, to a surface on a layer of non-NBC resistant polymeric material, most preferably silicone rubber, will now be described. By way of example only, the method includes the following steps:

a. making a silicone rubber diaphragm valve in known manner by a moulding process which vulcanised the rubber material;

b. removing the moulded diaphragm from the mould and carefully washing the moulded diaphragm with soapy water;

c. rinsing the washed diaphragm using cold clean water and laying out the rinsed diaphragm to dry;

d. exposing the surface of the now clean and dry diaphragm, to which an NBC resistant material is needed to be applied, to a high frequency and high voltage corona discharge which changes the surface and provides a keying area thereon onto which the NBC resistant material can be applied;

e. placing the treated and/or exposed diaphragm on a support member for subsequent treatment and processing;

f. spraying the treated and/or exposed diaphragm with a butyl solution to coat one or both surfaces (i.e., an inside or an outside surface) thereof with the NBC resistant material (several coats can be applied to increase the overall thickness of the coat allowing a drying time of approximately 10 minutes between each coat);

g. placing the diaphragm, coated with butyl, in an oven preheated to over 200° C. for approximately 30 minutes to vulcanise the butyl;

h. removing the vulcanised diaphragm from the oven and allowing the vulcanised diaphragm to cool; and

i. once the vulcanised diaphragm is cool, dusting the diaphragm with talcum powder and carefully removing the diaphragm from the support to complete the manufacturing process.

It will be appreciated that when the air adjacent the surface of the diaphragm to be coated is subjected to the high voltage corona discharge, the free electrons therein accelerate and ionise the gas. When the corona discharge is very strong, collisions between high velocity electrons with molecules of gas, result in no loss in momentum and electron avalanching occurs.

When the polymer component made of plastic or rubber is placed in the corona discharge path, the electrons generated during the discharge impact on the component with energy levels 2 or 3 times that necessary to break the molecular bond on the surface of most substrates and very reactive free radicals are created. These free radicals in the presence of oxygen react rapidly to form various chemical functional groups on the component which are the most effective at increasing surface energy and enhancing chemical bonding to other substrates such as carbonyl, carboxyl, hydroperoxide and hydroxyl groups.

A major advantage of surface treating a component with (i.e., a diaphragm) a high voltage corona discharge is that it modifies only the surface characteristics of the component without affecting the material bulk properties thereof.

A diaphragm made in accordance with the invention has been found to remain pliable and work satisfactorily down to temperatures as low as −50° C.

Although the present invention has been described with respect to a preferred method, it will be readily apparent to those having ordinary skill in the art to which it appertains that changes and/or modifications may be made thereto without departing from the spirit or scope of the invention.

What is claimed is:

1. An NBC resistant material comprising:
a non-NBC resistant polymeric layer having an outside and inside surface with a coating of NBC resistant material on at least one of the outside and the inside surfaces.

2. The material as claimed in claim 1, wherein the surface of the polymeric layer to which the coating of NBC resistant material is applied is treated with a high frequency and high voltage corona discharge which changes the surface of the polymeric layer to provide a keying surface thereon to which the coating of NBC resistant material adheres.

3. The material as claimed in claim 1, wherein the polymeric layer is vulcanised silicone rubber.

4. The material as claimed in claim 1, wherein the coating of NBC resistant material is a butyl rubber material.

5. A method of applying a coating of NBC resistant material to a non-NBC resistant polymeric layer comprising the steps of:
subjecting a surface of the polymeric layer to be coated to a high frequency and high voltage corona discharge to change the surface of the polymeric material to provide a keying surface thereon; and
applying the coating of NBC resistant material to the surface of the polymeric material.

6. The method as claimed in claim 5, wherein the polymeric layer is a vulcanised silicone rubber material.

7. The method as claimed in claim 5, wherein the NBC resistant material is butyl.

8. The method as claimed in claim 6, further comprising the step of washing with soapy water, rinsing and drying the vulcanised silicone rubber material prior to applying the corona discharge thereto.

9. The method as claimed in claims 7, further comprising the step of spraying the coating of NBC resistant material onto the keying surface.

10. The method as claimed in claim 9, further comprising the steps of:
spraying a plurality of coats of butyl onto the polymeric material; and
allowing each coat to dry before the application of a subsequent coat of butyl.

11. The method as claimed in claim 10, further comprising the step of vulcanising the silicone rubber material, coated with at least one layer of butyl, by placing the silicone rubber material, coated with the at least one layer of butyl in a preheated oven.

12. The method as claimed in claim 11, wherein the oven is preheated to a temperature above 200° C.

13. The method as claimed in claim 12, wherein the step of vulcanising takes place for approximately 30 minutes.

14. The method as claimed in claim 13, wherein the polymeric layer has an inside and outside surface, and wherein the method further includes the step of applying the NBC resistant material to at least one of the inside and outside surfaces.

15. The method as claimed in claim 5, further comprising the steps of:
spraying a plurality of coats of the NBC resistant material onto the polymeric material; and
allowing each coat to dry before the application of a subsequent coat.

16. The method as claimed in claim 15, further comprising the step of vulcanising the polymeric layer, coated with at least one layer of the NBC resistant material, by placing the polymeric layer, coated with at least one layer of the NBC resistant material in a preheated oven.

17. The method as claimed in claim 16, wherein the oven is preheated to a temperature above 200° C.

18. The method as claimed in claim 17, wherein the step of vulcanising takes place for approximately 30 minutes.

19. The method as claimed in claim 18, wherein the polymeric layer has an inside and outside surface, and wherein the method further includes the step of applying the NBC resistant material to at least one of the inside and outside surfaces.
